(19) United States
(12) Patent Application Publication
(10) Pub. No.: US 2009/0291035 A1
(43) Pub. Date: Nov. 26, 2009

(54) VACUUM CHAMBER

(76) Inventors: Michael Colin Begg, West Sussex (GB); James Cumming Ramage, West Sussex (GB)

Correspondence Address: Vierra Magen Marcus & DeNiro LLP, 575 Market Street, Suite 2500, San Francisco, CA, 94105, US

(21) Appl. No.: 12/126,408

(22) Filed: May 23, 2008

(51) Int. Cl. B01J 19/00

(52) U.S. Cl. 422/186.01

(57) ABSTRACT

A vacuum chamber 2 has walls having an inner layer 20 of a gas impermeable electrically non-conductive material and an outer layer 22 of a different electrically non-conducting material. The inner layer 20 is a polymeric film layer of Kapton® polyimide. The outer layer 22 is a composite material which includes reinforcing carbon or glass fibers bound in a matrix of epoxy resin. The vacuum chamber has end flanges for attaching it to adjacent parts of a vacuum system. The vacuum chamber is made by placing a sheet of Kapton® material around a mould and sealing its ends together. The composite material is then wound onto the inner layer in its wet form to provide the outer layer. The outer layer material is then cured to dry the epoxy resin, binding the layer to the inner layer, and the multi-layer structure removed from the mould. The vacuum chamber is particularly suitable for use in an ion implantation system in the presence of a time varying magnetic field.

### BACKGROUND

1. Field

The present invention relates to vacuum chambers, vacuum systems comprising such chambers, and methods of using and manufacturing such vacuum chambers and systems.

2. Description of the Related Art

Vacuum chambers are commonly used in a wide range of vacuum applications. The Applicant has realized that known vacuum chambers have certain drawbacks, particularly in applications in which a charged particle beam is passed through the chamber in the presence of a time varying magnetic field. This may occur, for example, in semiconductor processing applications, such as ion implantation systems. For example, some conventional vacuum chambers exhibit relatively high levels of electrical conductivity. This may result in undesirable effects such as inductive heating of the chamber walls occurring in use as a result of the production of eddy currents induced by the changing magnetic field, or attenuation of the magnetic field it is intended to produce.

In such applications it is conventional to use a ceramic vacuum chamber. However, the Applicant has realized that these ceramic chambers also have certain problems. For example, ceramic chambers tend to be relatively thick walled in order to provide acceptable levels of vacuum performance, increasing the associated costs, space requirements and, when a magnetic field is to be applied to a charged particle beam in the chamber, increasing the size, cost and power consumption of the magnets required to provide the field.

### SUMMARY AND DISCUSSION

The present invention seeks to provide an improved vacuum chamber which is particularly, although not exclusively, suitable for use in contexts in which a time varying magnetic field is externally applied to a charged particle beam within the vacuum chamber. However, it will be appreciated that the vacuum chambers of the present invention may be used in a broad range of applications outside this specific context.

In accordance with a first aspect of the invention there is provided a vacuum chamber, wherein the walls of the chamber are electrically non-conductive, and comprise an inner layer and an outer layer joined thereto, the inner and outer layers being formed of different electrically non-conductive materials, and wherein the inner layer is a gas impermeable layer.

In accordance with the invention therefore, the walls of the vacuum chamber are multi-layered walls, being formed from layers of different materials joined to one another. The inner layer is a gas impermeable, electrically non-conductive layer. The outer layer is also an electrically non-conductive layer. In this manner, the present invention provides an electrically non-conductive vacuum chamber.

It has been found that vacuum chambers of the present invention may be advantageously, although not exclusively, used in applications in which a time varying magnetic field is applied externally to a beam of charged particles within the chamber. Such arrangements are often used, for example in particle accelerators and semiconductor processing applications, such as ion implantation processes.

By providing a vacuum chamber which is electrically non-conductive, the level of inductive heating, and distortion of the magnetic field which may arise in comparison to conventional chambers, in which the walls are electrically conductive, may be reduced or eliminated. This is because, in contrast to conventional electrically conductive vacuum chamber walls, such as those of a conventional metal walled chamber, the walls of vacuum chambers in accordance with the present invention do not support the development of any significant eddy currents. Eddy currents are undesirable as, depending upon the context, they may cause effects such as the melting of components, or may interact with particles within the chamber. In this way, the present invention may provide a vacuum chamber which allows more precise selection of charged particles and focusing of particles in a desired region under the influence of the applied magnetic field, and may avoid the need to provide a cooling system. By “electrically non-conductive” it is meant that the relevant structure e.g. wall, layer etc. is, in practice, at least substantially electrically non-conductive under the conditions which might be expected to arise in use. Thus, the layer does not exhibit electrical conductivity of a level which would support significant eddy currents which could melt components of the system, e.g. the walls of the chamber, or influence any particles located in the chamber in an adverse way in a given context.

In accordance with the invention, the inner layer is the innermost layer of the walls which seals the vacuum space within the chamber. Accordingly, the layer is impermeable to gas to at least substantially prevent migration of particles through the layer into the vacuum space in use, allowing a vacuum seal of an acceptable level for the intended application of the chamber to be obtained.

In addition to the migration of particles through the walls of a vacuum chamber, another mechanism which may result in the release of particles into the interior vacuum space is known as outgassing. Outgassing is a phenomenon which may occur in vacuum systems when substances, e.g. particles, moisture, gases, solvents etc are released from the walls of the vacuum chamber under the action of a vacuum and enter the vacuum space. The outgassing properties of materials have been extensively studied, and materials with acceptably low outgassing behaviour for use as a vacuum sealing layer are well known. The walls of the vacuum chamber should exhibit a level of outgassing sufficiently low to ensure adequate performance in a given context, and preferably exhibit good levels of outgassing performance. Preferably the inner layer is a low outgassing layer. In preferred embodiments, the inner layer has an outgassing rate of less than 1×10⁻⁶ mbar l/sec, and preferably less than 1×10⁻¹⁰ mbar l/sec.

It will be appreciated that the inner layer may be made of any material which may be considered gas impermeable and electrically non-conductive within the context of the application. It is believed that the use of multi-layered walls in which the inner layer is gas impermeable and electrically non conductive is new and advantageous in its own right. Thus, from a further aspect the present invention provides; a vacuum chamber, wherein the walls of the chamber comprise an inner layer and an outer layer joined thereto, the inner and outer layers being formed of different materials, and wherein the inner layer is an electrically non-conductive, gas impermeable layer.

The present invention in accordance with this further aspect of the invention may incorporate any or all of the features described in relation to the other aspects of the invention, to the extend that it is not inconsistent therewith.

In accordance with the invention in any of its aspects and embodiments, preferably the inner layer is non-metallic. The layer may be a plastic layer, and is preferably a polymeric layer. In particularly preferred embodiments the inner layer is a polyimide layer. It has been found that the use of polymeric materials, such as polyimide, may be advantageous in that such materials may allow the inner layer to be made thinner while still providing adequate electrical insulating performance, strength and vacuum integrity. It has been found that the polyimide “Kapton®” may be particularly suitable for use as the inner layer. Kapton® has the chemical formula C₂₂H₁₀N₂O₅. Another example of a suitable polymer is Upilex®. Yet another polymeric material which may be used is a polyethylene terephthalate (PET) film, such as Mylar®. The inner layer is preferably formed from a single material and is not a composite material layer. In some embodiments the inner layer is a film layer. The layer may be a non ceramic layer.

In accordance with the invention, as the walls of the vacuum chamber include layers of different materials, the inner and outer layers may cooperate with one another to provide a multi-layered wall having the properties required of a vacuum chamber. Thus, each layer is not required to necessarily exhibit alone all of the properties required of a material forming a vacuum chamber wall, if, in combination, the inner and outer layers provide the necessary properties. This may reduce the constraints placed on a designer when selecting materials for walls, and allows the layers to be selected from a greater range of materials to tailor make a chamber having walls with a desired balance of properties, and allowing particular properties of the chamber to be optimized by appropriate selection of materials of the inner and outer layers. For example, the inner layer need not necessarily be self supporting, or sufficiently strong to withstand all conditions likely to be experienced by the chamber in use, provided that in combination with the outer layer it provides a composite wall of suitable robustness.

The outer layer is preferably a reinforcing layer which provides the bulk of the structure and integrity of the chamber. In some embodiments, therefore, the outer layer supports the inner layer. The inner layer may, for example be provided as a coating on the outer layer.

The outer layer may be low outgassing and/or gas impermeable. However, it will be appreciated that in accordance with the invention, it is not necessary for the outer layer material alone to provide gas impermeability or outgassing properties of a level adequate for use in a vacuum chamber provided that the inner layer is chosen to provide suitable gas impermeability and, preferably, low outgassing performance. In this way, the multi-layered wall structure allows materials which would not be suitable alone, i.e. in a single layer wall, to be used as the outer layer. In some embodiments, therefore, the outer layer is a gas permeable layer, and may exhibit levels of outgassing performance which would be considered relatively high in the context of a vacuum chamber.

The outer layer may be made of any material, but is preferably made of a composite material. Preferably the outer layer is a composite material layer. Such a composite material layer includes reinforcing material held in a matrix. Preferably the reinforcing material comprises reinforcing fibers and/or particles. Preferably the matrix is a polymer based matrix. The matrix acts to bind the reinforcing material into a coherent layer. In embodiments the reinforcing material may be selected from glass, carbon, polyester or Kevlar particles and/or fibers, or combinations thereof. Preferably the reinforcing material comprises glass and/or carbon fibers. Preferably the matrix is a polymeric matrix and comprises a bonding agent, for example a resin, such as epoxy resin. Other examples of suitable bonding agents include cyanate ester, phenolic resin, or polyimide (which may be initially combined with the reinforcing material when in the form of a liquid). For example, the layer may be formed from carbon or glass fibers or particles bound by epoxy resin i.e. a carbon fiber reinforced epoxy resin layer. In some embodiments, the layer is a carbon fiber or a glass reinforced polyester layer. Preferably the composite material is formed from only two materials. Preferably the composite layer is a wet bound composite layer. The layer may be a non ceramic layer. The use of a composite material layer provides advantages in terms of ease of manufacture, as the composite material may be wound onto e.g. a former to provide a chamber of a desired shape and size. Composite materials may also provide a lighter weight chamber for a given size chamber than would be possible using a conventional e.g. metallic material.

By forming the walls of the chamber from two layers of two different materials, it has been found that the overall thickness of the walls may be reduced in comparison to conventional vacuum chambers, in which the walls of the chamber are formed from a single material. In such conventional chambers, a single material must provide all necessary properties for the chamber walls, inevitably resulting in some compromise of the different properties. In contrast, in embodiments of the invention, the inner layer may be chosen to be a very thin layer having suitable gas impermeability and electrical non-conductivity, and a material with relatively high strength to thickness ratio may be selected for the outer layer, without being constrained by the need for the outer layer to be able to seal the vacuum space. The inner and outer layers are distinct layers joined to one another in face to face relationship, e.g. bonded to one another at an interface therebetween.

In some preferred embodiments the inner layer has a thickness of less than 1 mm, preferably less than 0.5 mm, and most preferably less than 0.2 mm. The thickness of the inner layer may be at least 0.05 mm, and preferably at least 0.1 mm. The thickness may be selected to be within a range selected from any combination of the above ranges. For example, in some embodiments the inner layer may be a 0.125 mm “Kapton®” or polyimide lining.

In preferred embodiments the outer layer has a thickness of less than 5 mm, and preferably less than 2.5 mm. The outer layer may have a thickness of at least 1 mm, and preferably at least 1.5 mm. The thickness of the outer layer may be in a range defined by any combination of these ranges. In some embodiments the outer layer is a carbon fibre composite layer having a thickness of 2 mm.

Vacuum chambers in accordance with the present invention may have a wall thickness of less than one half, or even a fifth to a tenth of the wall thickness of a conventional ceramic insulating vacuum chamber. The above exemplary construction i.e. a 2 mm thick carbon fibre composite material layer and a 0.125 mm thick “Kapton®” polyimide layer has been found to provide equivalent outgassing performance, strength and vacuum integrity to a 13 mm thick ceramic chamber. In this way, the present invention may provide a vacuum chamber which may be used where there are constraints in the space available, as well as providing low sensitivity to a changing magnetic field in use, eliminating the need for a cooling system.

In some preferred embodiments, the materials of the inner and outer layers are transparent to high energy beams, which may comprise high frequency electromagnetic radiation and/or high energy particles. Preferably the layers are transparent to high frequency beams having an energy of greater than 1×10³ eV. Preferably the materials are therefore transparent to electromagnetic radiation having a wavelength of less than 1×10⁻⁷ cm, or a frequency of greater than 3×10¹⁷ Hz. Preferably the inner and outer layers are transparent at least to X-rays and gamma radiation.

Embodiments in which the vacuum chamber is relatively transparent to high energy beams of electromagnetic radiation and/or particles may reduce the so-called “sputtering” effect when high energy beams are passed through the chamber. This is an effect which arises when such a beam hits the chamber wall, and produces lower energy secondary particles, or is absorbed by the walls. Such effects are undesirable. The production of secondary particles may interfere with the ability to analyze the primary beam intended to be investigated, or be able to reliably predict the properties of the beam or particles which is incident upon a material to be implanted in ion implantation processes. Absorption of a part of the beam or particles by the vessel wall may generate heat, necessitating cooling of the vessel walls.

While in the aspects and embodiments of the invention described above, the walls of the vacuum chamber are multi-layer walls, it is believed that the use of a wall material which is effectively formed from a combination of the non-conductive wall materials which may be used in the inner and outer layers of the multi-layer walls of vacuum chambers in accordance with the first or second aspect of the invention is advantageous in its own right.

In accordance with a further aspect of the invention, there is provided a vacuum chamber, wherein the walls of the chamber comprise an electrically non-conductive, gas impermeable composite material, the composite material comprising reinforcing material held in a matrix.

Preferably the walls of the chamber are formed from this material. In these aspects of the invention, while the walls may be formed of more than one layer of the material, the walls are preferably single layer walls. The matrix may be any suitable substance which may provide a gas impermeable electrically non conductive wall, and may be the same material as used to provide the inner layer in those multi-layer wall embodiments. Preferably the matrix is therefore a polymer based matrix. In preferred embodiments, therefore, the polymeric material is a polyimide polymeric layer. Most preferably, the polymeric layer is a Kapton® layer.

Preferably the reinforcing material comprises reinforcing fibers and/or particles. The reinforcing fibers or particles may be of the same type incorporated in the composite material used to provide the outer layer in the preferred embodiments of the multi-layer vacuum chamber to which the first aspect of the invention relates. Thus, the fibers or particles are preferably glass and/or carbon fibers or particles.

Walls of this construction may be formed by combining liquid polymer e.g. polyimide with reinforcing fibers to provide a mixed fibrous polymeric structure.

It has been found that a single layer wall of this construction may provide the necessary properties for use in the context of a vacuum chamber discussed above, e.g. outgassing performance, structural strength, electrical non conductivity and gas impermeability. The reinforcing fibers primarily provide strength, while the polymeric material is primarily responsible for providing the gas impermeability and low outgassing properties, and sealing the vacuum space. In these aspects and embodiments of the invention, the properties e.g. in terms of outgassing performance, transparency to electromagnetic radiation etc. of the single composite wall may be as described in relation to the inner layer of the multi-layer aspects and embodiments of the invention described above. The thickness of the walls may be in the ranges described above for the multilayer walls, or thinner.

In accordance with the invention in any of its aspects or embodiments, the vacuum chamber preferably further comprises end flanges to allow the chamber to be connected to adjoining pieces of apparatus in use. The end flanges may be integral with the main body of the chamber. In these embodiments, the end flanges may, for example, be formed from a composite material, which may be of the same type used to provide the or a layer of the walls of the chamber described above. Preferably the end flanges are attached to, for example bonded to, the main body of the chamber. In preferred embodiments in which the end flanges are made from an electrically conductive material, such as stainless steel or aluminum, the end flanges are preferably located at some distance from any region of the chamber to which a time varying magnetic field is applied in use. This may avoid or reduce the risk of eddy currents being produced, and/or the attenuation of a desired magnetic field by the end flanges. Alternatively, or additionally, in these embodiments, a special joint may be used between the flanges and the chamber to reduce any attenuation and/or risk of eddy current production by the flanges. The use of such electrically conductive materials to provide the end flanges may be advantageous in that that other components of a vacuum system are typically made of such materials. However, it will be appreciated that in some embodiments, the end flanges may be made from an electrically non-conductive material, such as a composite material. In some preferred embodiments the end flanges are joined to the walls of the vacuum chamber using a feathered joint. This is particularly advantageous in embodiments in which the walls of the vacuum chamber comprise a composite material, allowing the main composite body to be gradually feathered down to nothing in steps. The steps allow for a longer path and better bonding between the end flanges and the main body of the chamber.

The vacuum chamber in accordance with the invention in any of its aspects or embodiments may be of any suitable shape and form, depending upon the context in which it is intended to be used. The vacuum chamber may be an elongate chamber, and is preferably in the form of a pipe. The pipe may be cylindrical or non cylindrical. In some embodiments, the chamber is oval or quadrilateral shaped e.g. square or rectangular in vertical cross section.

Preferably the width of the vacuum chamber is in the order of from 1.5 to 2 times its height.

In general, the use of the structures of the present invention allows the wall thickness of a vacuum chamber to be reduced relative to the thickness required by, for example, a conventional metallic chamber of corresponding performance, and allows the potential problems associated with metallic electrically conducting chambers to be avoided, allowing the chamber to be used in a wider range of contexts, including alternating field applications. Cost reductions may be provided as the invention may avoid the need for the material of the chamber to be machined away during production, as is the case when conventional metal walled chambers are produced. For example, in some preferred embodiments, the outer layer of the chamber walls may be wound onto a mould, as described below, or in single layer embodiments, a mixture of liquid polymer and reinforcing fibers and/or particles may be moulded into an appropriate shape. The low cost and relatively high strength of the chamber may allow it to be made longer than a conventional e.g. ceramic chamber, having the advantage that the end flanges may be further from the magnet in use, allowing metallic or electrically conducting flanges or flange attachment materials to be used with reduced risk that the presence of the conductive materials may interfere with a magnetic field being applied to particles or a beam within the chamber.

In some embodiments, the vacuum chamber has a length of at least 26 cm, at least 30 cm, and in embodiments at least 40 cm. The length of the vacuum chamber may be less than 80 cm, less than 70 cm, less than 60 cm, or less than 50 cm.

The above ranges are merely exemplary, and it will be appreciated that the wall structure of vacuum chambers in accordance with the invention allows the vacuum chamber to be produced in a range of sizes and shapes, varying over orders of magnitude, from mm to metres in length, depending upon the intended application. In larger multi-layer vacuum chambers, a stronger e.g. thicker outer layer may be used to provide the necessary reinforcement to an inner layer which may still be maintained as thin as for a smaller chamber if desired. In single layer wall vacuum chambers in accordance with the further aspect of the invention, the strength of the walls may be tailored to a desired level by selecting the proportion and type of reinforcing fibers and/or particles used appropriately.

In the aspects of the invention in which the walls are multi-layer walls, preferably the walls of the vacuum chamber consist only of the inner and outer layers. Preferably therefore the inner layer is the innermost layer of the vacuum chamber walls, and the outer layer is the outermost layer of the vacuum chamber walls. The inner layer is thus preferably joined directly to the outer layer, and preferably the layers directly contact one another at an interface therebetween.

The first and second layers may be joined to one another in any suitable manner. The layers may be bonded to one another over a continuous area, or in discrete areas. In preferred embodiments the layers are bonded to one another using a plurality of discrete bond points. The pattern of bond points are preferably uniform, and preferably the bonding extends over the entire surface area over which the inner and outer layers contact one another. This may help to ensure that the layers remain securely bonded to one another over their entire surface area even when a vacuum pressure is applied. Particularly in the preferred embodiments in which the outer layer is gas permeable, a considerable level of external pressure will be exerted on the inner layer in use, which may tend to force the inner layer away from the outer layer at their interface.

The layers may be joined to one another with the aid of an external bonding substance, for example an adhesive or binder layer. In other embodiments, the layers may be joined to one another without the use of an external bonding substance, and are preferably autogenously bonded to one another. In some embodiments, the inner and outer layers are preferably formed from compatible materials to facilitate bonding of the layers to one another. For example, a component of the outer layer may be of the same general chemistry as the material of the inner layer, although the overall composite material of the outer layer is different to the material of the inner layer. For example, when the inner layer is a polymeric layer, e.g. a polyimide layer, the composite material layer may be selected to include a polyimide substance in the matrix and/or reinforcing material e.g. fibers. In some embodiments the second inner layer is applied as a coating or lining on the outer layer.

In some preferred embodiments the inner and outer layers are thermally bonded to one another. This may be achieved by applying one layer in a molten form to the other, or by applying heat to both layers after arranging the layers in contact with one another. Heat may then be applied in any suitable manner, e.g. by locating the layers in a heated environment, or by applying heat at discrete points. The bond points may be ultrasonic bond points, or may be produced using heat and/or pressure. Bonding of the layers to one another may be achieved during a curing operation for curing a composite outer layer. The heat applied may then bond the layers to one another over the interface therebetween e.g. over a substantially continuous area.

In accordance with the invention, the inner and outer layers are preferably coextensive at least over the area of the walls which encloses the vacuum space.

In some embodiments, the vacuum chamber may be made by building up the inner and outer layers respectively on an internal or external mould. Thus, the vacuum chamber may be formed by applying the inner layer material to a mould or former, and then applying the outer layer material to the outer surface of the inner layer material, or by applying the outer layer material to the inner surface of a mould, and applying the inner layer material to the internal surface of the outer layer material.

In accordance with the present invention there is further provided a method of forming a vacuum chamber in accordance with the invention, the method comprising the steps of applying an inner layer material to a mould, to provide a gas impermeable, electrically non-conductive layer, and applying an electrically non-conductive outer layer material to the outer surface of the inner layer, the outer layer material being of a different material to the inner layer. The outer surface of the inner layer is the surface opposite the mould facing surface of the layer. The outer layer material may be applied directly or indirectly to the outer surface of the inner layer e.g. with or without an intervening binder layer.

The inner and outer layer materials in accordance with this further aspect of the invention may be of the type described above in relation to the first aspect of the invention. This further aspect of the invention may include any or all of the features of the other aspects of the invention to the extent that they are not mutually exclusive therewith.

In preferred embodiments, in which the outer layer is a composite material layer, the outer layer may be wound onto the inner layer, and is preferably wet wound onto the layer. In this way, the chamber may be produced more cheaply than a conventional metal walled chamber in which the chamber must be produced by appropriate machining of a piece of metal. The inner layer may be supported on a mould or other suitable former during this operation. For example, the inner layer material e.g. Kapton®, may be placed around the former or mould, and sealed to provide a continuous layer in the region of the seam where its edges meet. The outer layer material may then be wound on to the inner layer.

In other embodiments, the chamber may be constructed using a blow moulding method. In this method, the outer layer material is inserted in a mould, and caused to conform to the shape of the mould, and the inner layer material is applied to the inner surface of the outer layer. This may be done by forcing the outer layer outwards against the walls of the mould to shape the layer. The sheet may be blown outwardly using air applied to its inner surface, or more preferably is pulled outwardly by applying a vacuum to the outside of the mould.

In preferred embodiments in which the outer layer is a composite material layer, the outer layer may be applied to the inner layer or a mould while in an uncured, or partially cured or “prepreg” form. If the material is in a “pre-preg” form, the e.g. resin of the composite layer will be semi cured, and not in its wet state. In embodiments in which the outer layer material is applied to the inner layer, the outer layer is preferably cured after it has been located around the inner layer. Thus, in these embodiments, the outer layer material may be wound onto the inner layer in its uncured state to provide an outer layer of a desired thickness and then cured. The curing operation will act to bond the outer layer material to the inner layer. The curing operation may involve curing the layer from a wet or pre-preg form, i.e. a partially cured form, to a final level of dryness. In embodiments in which the outer layer is applied to a mould before the inner layer material is applied thereto, the outer layer is preferably in at least a semi-cured or pre-preg form, for ease of application to the mould. Final curing may then be performed after application of the inner layer material thereto.

In some embodiments, the method of forming the vacuum chamber comprises the steps of, applying the inner layer material to a mould, winding the outer layer material onto the inner layer, and curing the outer layer material thereby binding the outer layer to the inner layer to obtain a multi-layer structure, and removing the multi-layer structure from the mould. The step of removing the structure from the mould may comprise movement of the mould or multi-layer structure or both.

Once the vacuum chamber structure has been produced, blanks may be placed over the ends, and the internal space evacuated to allow testing of the vacuum and leak rate of the chamber. This will usually be done after some bakeout.

The vacuum chambers of the present invention may be used in any desired application. As discussed above, the vacuum chambers are particularly suitable for use where the vacuum chamber is likely to be in the presence of a changing e.g. alternating magnetic field. The use of the electrically non-conducting layers for the walls may reduce the level of inductive heating, and consequent risk of components melting, and reduce the production of eddy currents which might otherwise distort the magnetic field in such a context.

In accordance with a further aspect of the invention, the present invention therefore provides a vacuum system comprising a vacuum chamber in accordance with the invention of any of its aspects or embodiments. In preferred embodiments the vacuum system further comprises means for applying a time varying e.g. alternating magnetic field to a charged particle beam within the vacuum chamber in use. For example, the means may be one or more magnets arranged to apply a time varying e.g. alternating magnetic field to the chamber. The magnets are preferably arranged externally to the chamber. One application in which a time varying or alternating magnetic field is applied in this way is that of semi conductor processing, and more particularly ion implantation. In preferred embodiments, the system is a semiconductor processing system, and preferably an ion implantation system. Preferably the semiconductor processing relates to the fabrication of semiconductors. The use of the chamber of the present invention in which the walls are non conducting reduces the risk of contamination of the vacuum by metal ions which may occur when a conventional metal walled vacuum chamber is used in an ion implantation system. However, alternating fields are used in other applications in which particle beams are present. For example, alternating fields are used in accelerators which may be used in a range of contexts, including scanning items such as trucks and baggage. It has been found that the present invention is particularly applicable in any context involving the use of alternating magnetic fields in combination with charged particle beams.

In accordance with a further aspect the present invention provides a method for using a vacuum chamber in accordance with the present invention in any of its aspects or embodiments, the method comprising passing a charged particle beam through the vacuum chamber, and applying a time varying magnetic field to the vacuum chamber. Preferably the method is a semiconductor processing method, and most preferably an ion implantation method. Preferably the semiconductor processing method involves semiconductor fabrication. Preferably the time varying magnetic field is an alternating field.

While the inner layer has been described as being an electrically non-conductive layer in the multi-layer embodiments of the invention described above, it is envisaged that in some contexts, for example where relatively small or slowly time varying magnetic field is applied to the vacuum chamber, a thin metal layer may be used as the inner layer of the chamber walls, provided that it is suitably low out gassing, and does not support the development of eddy currents above a tolerable level for that context.

In accordance with a further aspect of the invention, there is provided a semi-conductor processing, preferably ion implantation vacuum system comprising a vacuum chamber, wherein the vacuum chamber has walls comprising an inner layer and an outer layer joined thereto, the inner and outer layers being made of different materials, wherein the inner layer is a gas impermeable layer.

The vacuum chamber in this further aspect may include any or all of the features of the other aspects of the invention to the extent that they are not mutually exclusive therewith, and may be produced and used in accordance with any of the materials previously described in relation to the other aspects of the invention. In these embodiments, the inner layer may be a metallic layer. The layer should be sufficiently thin to ensure that any electrical conductivity is at a relatively low level, below that which might e.g. cause eddy current to be produced above a tolerable level, or cause any other undesirable interference with the function of the chamber in a given context. The outer layer may be electrically non conductive or may exhibit some electrical conductivity to a suitable level for the given context. The outer layer may is preferably a composite material layer of the type described in relation to the first aspect of the invention.

One embodiment includes a method of forming a vacuum chamber, comprising applying an inner layer material to a mold to provide a gas impermeable, electrically non-conductive layer and applying an electrically non-conductive outer layer material to the outer surface of the inner layer. The outer layer material is of a different material than the inner layer.

Some preferred embodiments of the present invention will now be described by way of example, and with reference to the accompanying drawings of which:

### BRIEF DESCRIPTION OF THE DRAWINGS

FIG. 1 is a perspective view from the side and one end of a vacuum chamber in accordance with an embodiment of the invention;

FIG. 2 is a perspective view from the side and other end of the vacuum chamber of FIG. 1;

FIG. 3 is a transverse cross sectional view of the vacuum chamber 1 taken along the axis of the chamber across its width along the line A-A marked in FIG. 1;

FIG. 4 is a transverse cross sectional view of the chamber taken along the axis of the chamber across the height thereof along the line B-B marked on FIG. 2 and perpendicular to line A-A;

FIG. 5 illustrates the composite wall structure of the chamber in accordance with one embodiment of the invention in more detail;

FIG. 6 shows schematically the region of the connection between the vacuum chamber walls and an end flange in accordance with one preferred embodiment; and

FIG. 7 illustrates in more detail the feathered joint used to connect the vacuum chamber wall to the end flange in the region of “7” marked on FIG. 6.

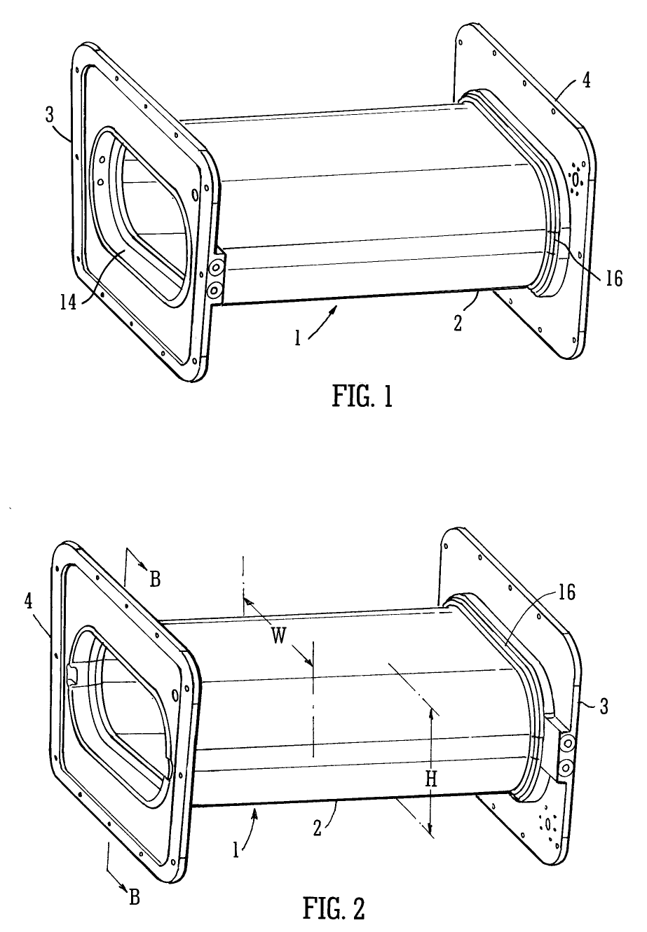

A preferred embodiment of the present invention will now be described with respect to FIGS. 1 to 7.

### DETAILED DESCRIPTION

As may be seen most readily in FIGS. 1 and 2, the vacuum chamber 1 is rectangular in vertical cross section, and has side walls 2 extending between the ends thereof. At each end of the chamber there is a flange 3,4 respectively joined thereto for connecting the vacuum chamber 2 adjoining apparatus in a vacuum system.

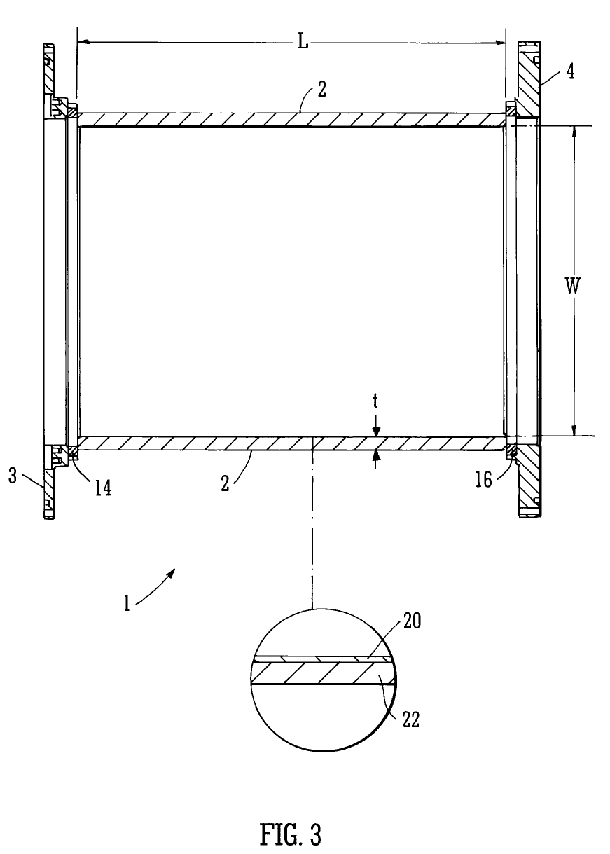

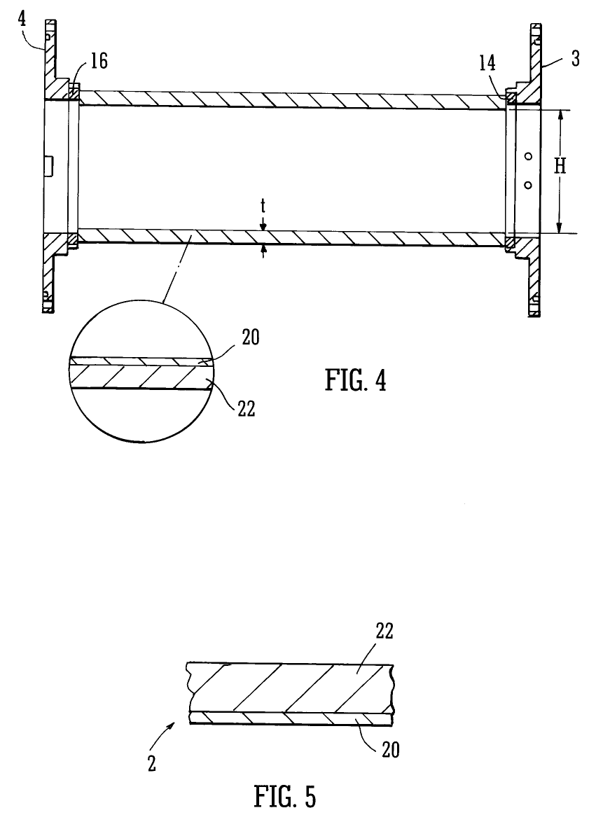

In the particular illustrated embodiment, the width W of the vacuum chamber exceeds its height. The width is around at least twice the height. The width W of the chamber measured between the internal surfaces of its walls along the line W of FIG. 3 is around 320 mm. The corresponding height of the vacuum chamber marked H in FIG. 4 is around 127 mm.

The walls of the cylinder have a thickness of around 2.125 mm. The thickness is marked t on FIGS. 3 and 4. The vacuum chamber has a length L of 45 cm. It will be appreciated that these dimensions are exemplary only, and the vacuum chamber may be of any dimensions suitable for an intended application. The present invention is applicable to chambers over a wide range of sizes, from dimensions in the order of millimeters to many meters.

The construction of the walls is shown schematically in the cross sectional view of FIG. 5, and the magnified views in FIGS. 3 and 4. The walls are formed from an inner layer 20 of a gas impermeable electrically non-conductive material, and an outer layer 22 of a different electrically non-conductive material. The inner layer 20 is a polymeric film layer of “Kapton®” polyimide. Kapton® has the chemical formula C22H10N2O5.

The inner layer is directly joined to the outer layer 22 which is a composite material layer. The outer layer 22 is itself made up of two different materials, a reinforcing material and a polymeric matrix to provide a composite material as known in the art. The outer layer is electrically non-conductive. In embodiments, the outer layer includes glass or carbon fibers. The matrix may be an epoxy resin. In other embodiments, the outer layer may be a glass reinforced polyester layer. The inner and outer layers are bonded to one another using a uniform pattern of bonds. It will be appreciated that while the individual e.g. carbon fibers of a composite material may have relatively high electrical conductivity in these embodiments, because they are surrounded by an electrically insulating matrix substance, such as epoxy resin, the overall composite material may have be non electrically conductive as required in accordance with these embodiments of the invention. For example, it has been found that the electrical conductivity of chambers made in this way may allow alternating fields of up to 1 KHz to pass through and experience a phase shift of less than 45 degrees as a result of eddy current flow in the chamber.

The inner layer 20 provides a low outgassing gas impermeable layer which seals the vacuum, while the outer layer 22, which is in itself is not gas impermeable, provides a reinforcing layer, rendering the composite wall material 2 comprising the inner and outer layers 20,22 self supporting. In an exemplary embodiment, the outer layer 22 has a thickness of 2 mm and the inner layer 20 a thickness of 0.125 mm. The thickness of the outer layer may be selected as required to provide a required level of strength. The inner layer is a low out gassing layer, sealing the vacuum from the outer composite layer, which may not necessarily be low out gassing. In embodiments, the inner layer has an outgassing rate of less than 1×10−6 mbar l/sec, and preferably less than 1×10−10 mbar l/sec.

The end flanges are aluminum or stainless steel end flanges in the embodiments shown. Such materials are advantageous as they are frequently used in other components of a vacuum system, facilitating connection of the vacuum chamber thereto. However, it will be appreciated that rather than using metallic electrically conductive end flanges, non electrically conductive materials, e.g. a composite material, may be used.

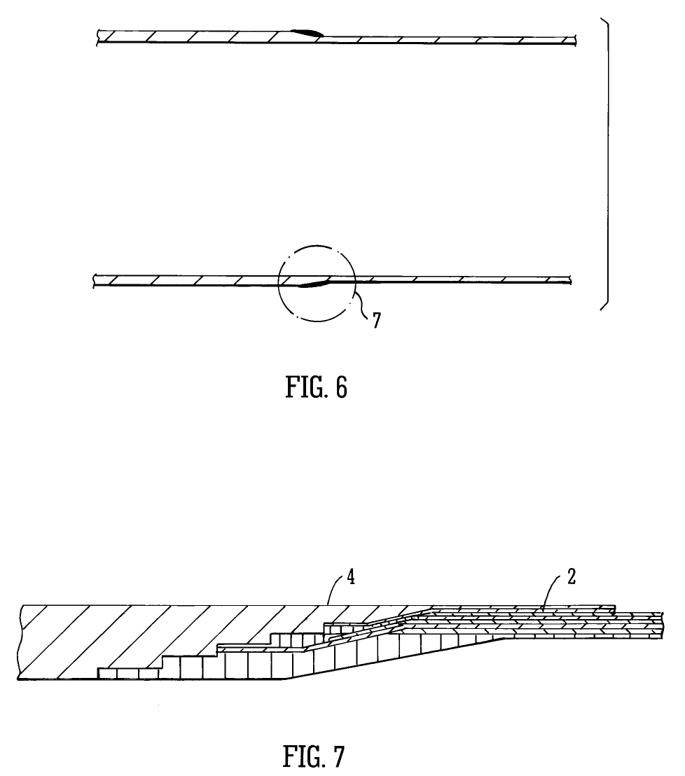

With reference to FIGS. 1-4, it will be seen that the flanges 3 and 4 are connected to the walls of the vacuum chamber trapping peripheral seals 14, 16 respectively therebetween. FIGS. 6 and 7 illustrate a feathered joint which may be used to connect the walls of the vacuum chamber to an end flange in accordance with one embodiment of the invention. The sidewalls 2 of the chamber are feathered down to nothing in gradual steps allowing for a longer path and good bonding between the end flanges and the main body of the chamber.

It will be appreciated that, as set out above, an electrically non conductive layer is one which will exhibit no significant levels of electrical conductivity in the intended application of the chamber, i.e. such that no significant eddy currents are produced. The layer may be completely electrically non conductive or may be substantially electrically non conductive, with any electrical conductivity being of a very low level in accordance with these objectives. Similarly, gas impermeable layers in accordance with the invention are gas impermeable to the extent that they at least substantially prevent the migration of particles into the vacuum space in use, allowing a vacuum seal of an acceptable level for the intended application of the chamber to be obtained.

It will be appreciated that in accordance with embodiments of the present invention, the walls of the vacuum chamber are composite walls formed from an inner gas impermeable, electrically non-conducting layer, and an outer electrically non conducting layer which is itself a composite material layer. The composite material outer layer provides structural integrity to the vacuum chamber allowing a thinner sealing inner layer to be used in conventional chambers. For example, the walls may be in the order of a fifth to a tenth of the width of those required if made only of ceramic material. For this reason, the vacuum chamber may be lighter weight, and of generally more compact construction than a conventional vacuum chamber, allowing smaller magnets to be used. This may lead to accompanying cost savings, and also reduces the amount of power required in comparison to vacuum chambers with thicker walls, in which a magnetic field must be sufficiently strong to penetrate the walls.

The lower cost of the chamber may allow it to be made longer than a conventional ceramic chamber, also having advantage that the end flanges may be further from the magnet in use. However, great flexibility is provided in the design of the chamber and end flanges. For example, non metallic end flanges may be used, e.g. of a composite material, or, if metallic end flanges are used, the method of joining the flanges to the chamber may be selected appropriately to reduce the level of any eddy currents produced if required.

As the walls of the vacuum chamber are electrically non conductive, problems of conventional metal chambers e.g. in terms of production of eddy currents and interference on particles within the chamber, may be avoided. The chambers of the present invention may be used in contexts in which a time varying magnetic field e.g. an alternating field, is applied to the chamber, without the danger of melting of the chamber, and without adversely affecting particles within the chamber, e.g. by contamination with metal ions released from the walls. It has been found that for a corresponding level of performance and robustness, the present invention allows a chamber to be used which is lighterweight and more compact than would be possible using a conventional ceramic or metallic chamber. This is primarily as a result of the thinner wall structures which may be used. The use of composite materials in the wall structure also may provide a relatively higher strength to weight ratio than may be achieved using conventional materials. It will be appreciated that for larger structures, or applications in which higher strength is required of the chamber, a thicker or stronger outer reinforcing layer may be required. The properties of the inner and outer layers may be tailored as required to provided a multi-layered vacuum chamber wall having desired properties.

The vacuum chamber may be formed from an inner and outer layer which result in the chamber being transparent to high frequency electromagnetic radiation or high energy particle beams. In these embodiments, the sputtering effect, in which secondary particles are produced when a beam hits the vessel wall, or heat is produced on absorption of a beam hitting the vessel wall may be reduced, reducing the requirement for cooling the vessel walls, and reducing the likelihood of contamination of a particle beam.

The vacuum chamber of the present invention may be used in a range of applications. However, the vacuum chamber is particularly applicable in a context where a time varying magnetic field is to be applied to a charged particle beam moving through the vacuum envelope. This is because the presence of the inner non-conductive layer reduces the level of inductive heating, and distortion of the magnetic field which may arise in use. In use, the vacuum chamber may therefore be joined using the flanges at either end thereof to other components of a semi-conductor processing system, such as an ion implantation system or other semiconductor fabrication process. One application which widely uses such time varying magnetic fields is that of semiconductor processing, and particularly ion implantation. However, there are many other applications which use a time varying or alternating magnetic field in the region of a charged particle beam, such as particle accelerators. Particle accelerators now find wide ranges of application, including in the context of scanning items, such as baggage or vehicles.

While the inner layer has been described as being a non-electrically conductive layer, it is envisaged that in some contexts, for example where relatively small or slowly time varying magnetic field is applied to the vacuum chamber, a thin metal layer may be used as the inner layer of the chamber walls, provided that it is suitably low out gassing, and does not support the development of eddy currents above a tolerable level for the given context. The use of a metal layer may also provide a more attractive shiny inner vacuum sealing layer, which is desirable in some contexts, for example high vacuum applications.

While the embodiments described above include multi-layer walls, in accordance with another embodiment of the invention, the walls may be comprise a gas impermeable, electrically non-conductive composite material. In embodiments the material is a polyimide material including carbon or glass reinforcing fibers. For example, the fibers may be introduced into the polyimide material while wet. In one exemplary embodiment, the walls are formed from a single layer of this material. It will be appreciated that in these embodiments, the walls are effectively provided by a material which is a combination of the inner and outer layer materials of the first embodiment of the invention, such that they provide properties in terms of outgassing performance, electrical non conductivity, gas impermeability and transparency similar to the walls of the first embodiment of the invention.

The vacuum walls of chambers in accordance with any aspects and embodiments of the invention including multi-layer walls, may be constructed in any suitable manner. For example, the chamber may be built up on a mould, starting with the inner impermeable layer, and then applying the composite material which will form the outer layer thereto. The composite material outer layer may be applied by winding it around the inner layer e.g. as a wet wound composite layer.

One typical method of producing a vacuum chamber in accordance with the embodiment illustrated in FIGS. 1-6 above would include the following steps. First, a sheet of Kapton® is placed around a former. The former may be, for example, a metal former. The seam where the edges of the Kapton® sheet meet are sealed. The former having the Kapton® sheet thereon is then rotated while epoxy wetted glass or carbon fibers are allowed to wrap themselves around the former. Once a desired wall thickness has been achieved, the former and winding assembly are taken to an oven to cure the epoxy resin. This causes the Kapton® to stick to the glass or carbon fibers, providing a structure bonded together by epoxy glue. Finally, the former is withdrawn from the structure, i.e. through the open ends thereof. The vacuum may be measured after some back out by placing blanks over the ends of the chamber and pumping all the air out to measure the vacuum and leak rate to verify that it is of the desired level. Rather than using wet epoxy resin, the composite material may already be in a “pre-preg” form, i.e. semi cured when applied to the Kapton®.

In other embodiments, the chamber may be constructed using a blow moulding method, involving inserting a prepregnated composite material sheet to form the outer layer in a mould, and applying a vacuum to the outside of the mould to pull the sheet against the face of the mould before curing. The moulded and cured outer layer may then be coated internally with the material of the inner gas impermeable layer.

In embodiments of the invention, any mould may be removed through an open end or ends of the vacuum chamber, being collapsed if required.

It will be appreciated that the present invention may avoid the costs associated with the manufacture of conventional vacuum chambers, in which it may be necessary to machine metal into a desired shape.

We claim:

1. A vacuum chamber, comprising:
electrically non-conductive walls, the walls comprise an inner layer and an outer layer joined thereto, the inner and outer layers being formed of different electrically non-conductive materials, and wherein the inner layer is a gas impermeable layer.

2. The vacuum chamber of claim 1, wherein:
the inner layer is a polymeric layer, and is preferably a polyimide layer.

3. The vacuum chamber of claim 1, wherein:
the inner layer is a film layer.

4. The vacuum chamber of claim 1, wherein:
the outer layer is gas permeable.

5. The vacuum chamber of claim 1, wherein:
the outer layer is a composite material layer comprising reinforcing material held in a polymer based matrix.

6. The vacuum chamber of claim 5, wherein:
the reinforcing material comprises fibers and/or particles, preferably glass or carbon fibers and/or particles.

7. A vacuum chamber, comprising:
walls comprising an electrically non-conductive and gas impermeable material, the material being a composite material comprising reinforcing material held in a matrix.

8. The vacuum chamber of claim 7, wherein:
the matrix is a polymer based matrix, preferably a polyimide based matrix, and the reinforcing material comprises fibers and/or particles, preferably glass or carbon fibers and/or particles.

9. The vacuum chamber of claim 1, wherein the thickness of the walls is less than 2.5 mm, and preferably less than 2.2 mm.

10. A vacuum system comprising the vacuum chamber of claim 7, wherein:
the system is a semi-conductor processing system.

11. The vacuum system of claim 10, further comprising:
a sub-system for applying a time varying magnetic field to a charged particle beam within the vacuum chamber in use.

12. A vacuum system, comprising:
a vacuum chamber having walls, wherein the walls of the vacuum chamber are electrically non-conductive and comprise an inner layer and an outer layer joined thereto, the inner and outer layers being formed of different electrically non-conductive materials, and wherein the inner layer is a gas impermeable layer.

13. The vacuum system of claim 12, wherein:
the system is a an ion implantation system.

14. The vacuum system of claim 12, wherein:
the inner layer is a polymeric layer, and is preferably a polyimide layer.

15. The vacuum system of claim 12, wherein:
the outer layer is a composite material layer comprising a reinforcing material in the form of particles or fibers, and a binder.

16. The vacuum system of claim 15, wherein:
the reinforcing material comprises glass or carbon fibers.

17. The vacuum system of claim 12, further comprising:
a sub-system for applying at time varying magnetic field to a charged particle beam within the vacuum chamber in use.

18. A semi-conductor processing system, comprising:
a vacuum chamber having walls, the walls comprise an inner layer and an outer layer joined thereto, the inner and outer layers are made of different materials, and wherein the inner layer is a gas impermeable layer.

19. The semi-conductor processing system of claim 18, wherein:
the inner layer is a metallic layer.

20. The semi-conductor processing system of claim 18, further comprising:
a sub-system for applying a time varying magnetic field to a charged particle beam within the vacuum chamber in use.
